(19) United States
(12) Patent Application Publication
(10) Pub. No.: US 2025/0059824 A1
(43) Pub. Date: Feb. 20, 2025

(54) Garage Door Perimeter Sealing Device

(71) Applicant: Ernest Martell, II, Lake Havasu City, AZ (US)

(72) Inventor: Ernest Martell, II, Lake Havasu City, AZ (US)

(21) Appl. No.: 18/804,997

(22) Filed: Aug. 14, 2024

Related U.S. Application Data
(60) Provisional application No. 63/519,353, filed on Aug. 14, 2023.

(51) Int. Cl. E06B 7/23

(52) U.S. Cl. CPC E06B 7/2316; E06B 7/2314

(57) ABSTRACT

A garage door perimeter sealing device is provided. The device is designed to enhance the sealing and aesthetic of a garage door jamb. The device comprises a retainer plate and a steel member that can be secured to the jamb using fasteners. In one embodiment, the steel member is equipped with a seal, preferably made from durable rubber that is not prone to cracking or shrinking, positioned at a 45-degree angle extending towards a garage door perimeter to effectively block moisture, debris, and air from entering the garage. In a different embodiment, a portion of the seal is positioned between the steel member and retainer plate. The device is customizable in color, fit, and finish, allowing it to match various aesthetic preferences.

### CROSS-REFERENCE TO RELATED APPLICATION

The present application claims priority to, and the benefit of, U.S. Provisional Application No. 63/519,353, which was filed on Aug. 14, 2023, and is incorporated herein by reference in its entirety.

### FIELD OF THE INVENTION

The present invention relates generally to the field of garage doors. More specifically, the present invention relates to a garage door perimeter sealing device comprised of a three-part construction that provides a more durable and visually appealing garage door seal. Accordingly, the present disclosure makes specific reference thereto. Nonetheless, it is to be appreciated that aspects of the present invention are also equally applicable to other like applications, devices, and methods of manufacture.

### BACKGROUND

Existing garage door seals are constructed from vinyl, a material known for its susceptibility to cracking and shrinking within just a few months after installation. This degradation can lead to a variety of problems, including the introduction of unwanted debris, such as dirt, leaves, and pests, into the garage space. Moreover, an improperly sealed garage door allows moisture to seep in, potentially causing long-term damage not only to the door itself but also to any items stored inside the garage, including vehicles, tools, and other valuable possessions.

In addition to the practical issues, the aesthetic impact of a deteriorating garage door seal should not be overlooked. Many existing seal products on the market lack visual appeal and can significantly diminish the appearance of a home, particularly one that is otherwise well-maintained or newly built. The unsightly nature of these seals can make the garage door—and by extension, the entire home—appear older and less cared for, which may affect the overall curb appeal and even the property value.

The need for a more durable, visually pleasing solution is apparent, one that not only effectively protects the garage from external elements but also complements the home's appearance, enhancing rather than detracting from its overall aesthetic.

Therefore, there exists a long-felt need in the art for an improved garage door seal. There also exists a long-felt need in the art for a garage door perimeter sealing device. More specifically, there exists a long-felt need in the art for a garage door perimeter sealing device that provides a more durable garage door seal than existing garage door seals known in the art. Further, there exists a long-felt need in the art for a garage door perimeter sealing device that provides a more durable garage door seal than existing garage door seals known in the art wherein the device also offers improved visual appeal and styling.

The subject matter disclosed and claimed herein, in one embodiment thereof, comprises a garage door perimeter sealing device. The device is designed to enhance the sealing and aesthetic of a garage door jamb. The device comprises a retainer plate and a steel member that can be secured to the jamb using fasteners. In one embodiment, the steel member is equipped with a seal, preferably made from durable rubber that is not prone to cracking or shrinking, positioned at a 45-degree angle extending towards a garage door perimeter to effectively block moisture, debris, and air from entering the garage. In a different embodiment, a portion of the seal is positioned between the steel member and retainer plate. The device is customizable in color, fit, and finish, allowing it to match various aesthetic preferences.

In this manner, the garage door perimeter sealing device of the present invention accomplishes all the forgoing objectives and provides an improved garage door seal. More specifically, the device provides a more durable garage door seal than existing garage door seals known in the art. In addition, the device offers improved visual appeal and styling over existing garage door seals known in the art.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a garage door perimeter sealing device comprised of a retainer plate, a steel member, a seal, and at least one fastener. The retainer plate is comprised of at least one opening. The retainer plate receives at least one steel member. The steel member may be comprised of at least one opening. In one embodiment, at least one fastener, such as but not limited to a screw, can be placed through the opening of the steel member, through the opening of the retainer plate, and into the jamb area in front of a garage door. In a further embodiment, a top surface of the retainer plate may be comprised of at least one receiving area such as but not limited to a groove, a channel, etc. that may receive a portion or the entirety of the steel member to further secure the steel member to the retainer plate without the need for a fastener to be placed through both the steel member and retainer plate.

The retainer plate and steel member may have any color, fit, or finish (including a simulative finish that resembles another material such as but not limited to wood, stone, etc.) known in the art. This allows for the device to achieve improved visual appeal over existing garage door jambs.

The top surface of the steel member may be comprised of at least one seal in one embodiment. The seal is preferably comprised of a rubber that is resistant to shrinking, cracking, and warping while eliminating the ability for moisture, debris, and air to enter a garage through a perimeter opening of a garage door. The seal is preferably positioned 45 degrees relative to a vertical axis (or in another embodiment, a horizontal axis) of the steel member (i.e., such that the seal points towards a perimeter of a garage door while extending away from the top surface and/or member and plate). As a result, the seal adequately seals the perimeter of the garage door.

The present invention is also comprised of a method of using the device. First, a device is provided comprised of a retainer plate comprised of a first opening, a steel member comprised of a second opening, at least one fastener, and at least one seal. Then, a portion of the seal can be placed between the retainer plate and the steel member. Finally, the retainer plate, seal, and steel member can be placed in front of a garage door (to the left, right, or top of the door) and secured into a garage door jamb by driving the fastener through the first opening and second opening and into the jamb such that the seal covers/seals a perimeter edge of the garage door.

Accordingly, the garage door perimeter sealing device of the present invention is particularly advantageous as it provides an improved garage door seal. More specifically, the device provides a more durable garage door seal than existing garage door seals known in the art. In addition, the device offers improved visual appeal and styling over existing garage door seals known in the art. In this manner, the garage door perimeter sealing device overcomes the limitations of existing garage door seals known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear view of one potential embodiment of a garage door perimeter sealing device of the present invention in accordance with the disclosed architecture;

FIG. 2 illustrates a top view of one potential embodiment of a garage door perimeter sealing device of the present invention in accordance with the disclosed architecture;

FIG. 3 illustrates a cross-sectional side view of one potential embodiment of a garage door perimeter sealing device of the present invention in accordance with the disclosed architecture;

FIG. 4 illustrates a cross-sectional side view of one potential embodiment of a garage door perimeter sealing device of the present invention installed into a garage door jamb in front of a garage door in accordance with the disclosed architecture;

FIG. 5 illustrates a perspective view of one potential embodiment of a garage door perimeter sealing device of the present invention installed into a garage door jamb in front of garage door in accordance with the disclosed architecture; and

FIG. 6 illustrates a flowchart of a method of using one potential embodiment of a garage door perimeter sealing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved garage door seal. There also exists a long-felt need in the art for a garage door perimeter sealing device. More specifically, there exists a long-felt need in the art for a garage door perimeter sealing device that provides a more durable garage door seal than existing garage door seals known in the art. Further, there exists a long-felt need in the art for a garage door perimeter sealing device that provides a more durable garage door seal than existing garage door seals known in the art wherein the device also offers improved visual appeal and styling.

The present invention, in one exemplary embodiment, is comprised of a garage door perimeter sealing device. The device is comprised of a retainer plate, a steel member, a seal, and at least one fastener. The retainer plate is comprised of at least one opening and receives at least one steel member. The steel member may be comprised of at least one opening. In one embodiment, at least one fastener, such as but not limited to a screw, can be placed through the opening of the steel member, through the opening of the retainer plate, and into the jamb area in front of a garage door. In a further embodiment, a top surface of the retainer plate may be comprised of at least one receiving area such as but not limited to a groove, a channel, etc. that may receive a portion or the entirety of the steel member to further secure the steel member to the retainer plate without the need for a fastener to be placed through both the steel member and retainer plate.

The retainer plate and steel member may have any color, fit, or finish (including a simulative finish that resembles another material such as but not limited to wood, stone, etc.) known in the art. This allows for the device to achieve improved visual appeal over existing garage door jambs.

The top surface of the steel member may be comprised of at least one seal in one embodiment. The seal is preferably comprised of a rubber that is resistant to shrinking, cracking, and warping while eliminating the ability for moisture, debris, and air to enter a garage through a perimeter opening of a garage door. The seal is preferably positioned 45 degrees relative to a vertical axis (or in another embodiment, a horizontal axis) of the steel member (i.e., such that the seal points towards a perimeter of a garage door while extending away from the top surface and/or member and plate). As a result, the seal adequately seals the perimeter of the garage door.

The present invention is also comprised of a method of using the device. First, a device is provided comprised of a retainer plate comprised of a first opening, a steel member comprised of a second opening, at least one fastener, and at least one seal. Then, a portion of the seal can be placed between the retainer plate and the steel member. Finally, the retainer plate, seal, and steel member can be placed in front of a garage door (to the left, right, or top of the door) and secured into a garage door jamb by driving the fastener through the first opening and second opening and into the jamb such that the seal covers/seals a perimeter edge of the garage door.

Accordingly, the garage door perimeter sealing device of the present invention is particularly advantageous as it provides an improved garage door seal. More specifically, the device provides a more durable garage door seal than existing garage door seals known in the art. In addition, the device offers improved visual appeal and styling over existing garage door seals known in the art. In this manner, the garage door perimeter sealing device overcomes the limitations of existing garage door seals known in the art.

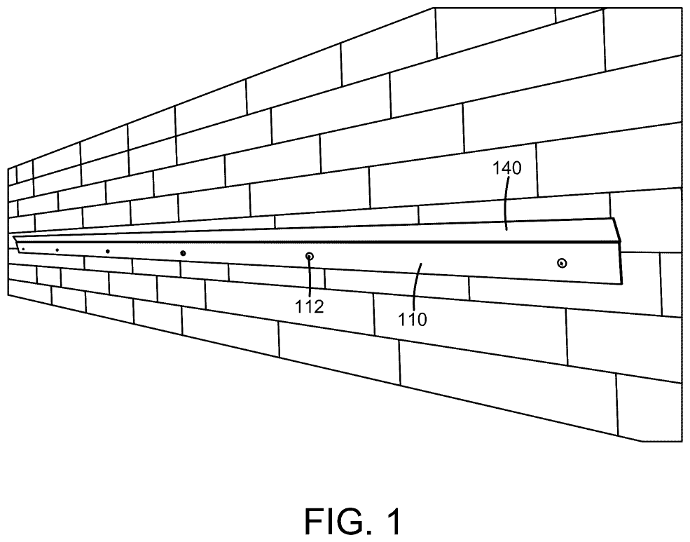

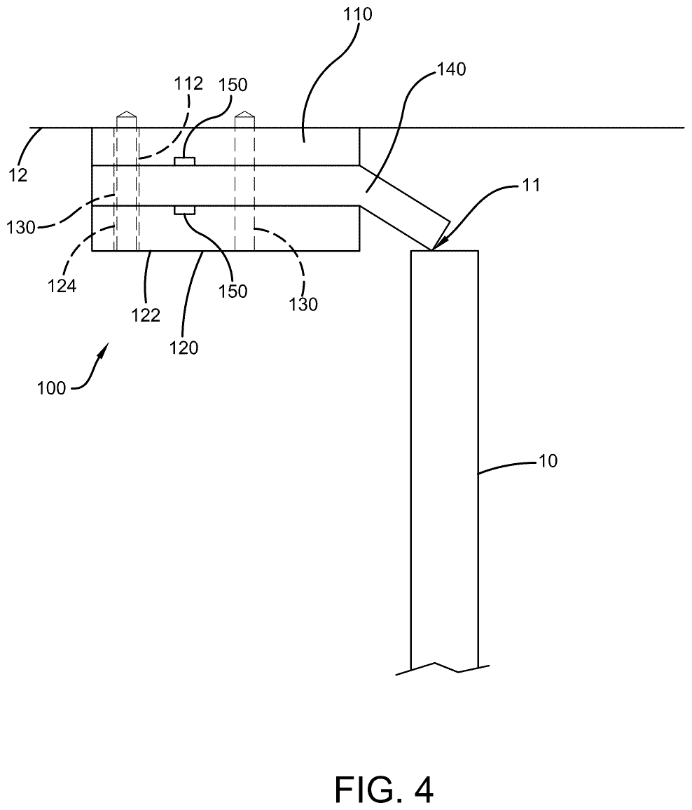

Referring initially to the drawings, FIG. 1 illustrates a rear view of one potential embodiment of a garage door perimeter sealing device 100 of the present invention in accordance with the disclosed architecture. The device 100 is comprised of a retainer plate 110, a steel member 120, a seal 140, and at least one fastener 130. The retainer plate 110 is preferably made from an aluminum material but may be made from a corrosion-resistant metal (or any other material). The retainer plate 110 is comprised of at least one opening 112. The retainer plate 110 receives at least one steel member 120. The steel member 120 may be comprised of at least opening 124. In one embodiment, at least one fastener 130, such as but not limited to a screw, can be placed through the opening 124 of the steel member 120, through the opening 112 of the retainer plate 110, and into the jamb area 12 in front of a garage door 10. In one embodiment, both or either opens 112,124 may be counterstunk. In a further embodiment, a top surface 114 of the retainer plate 110 may be comprised of at least one receiving area 116 such as but not limited to a groove, a channel, etc. that may receive a portion or the entirety of the steel member 120 to further secure the steel member 120 to the retainer plate 110 without the need for a fastener 130 to be placed through both the steel member 120 and retainer plate 110, as seen in FIG. 4.

The retainer plate 110 and steel member 120 may have any color, fit, or finish (including a simulative finish that resembles another material such as but not limited to wood, stone, etc.) known in the art. This allows for the device 100 to achieve improved visual appeal over existing garage door jambs.

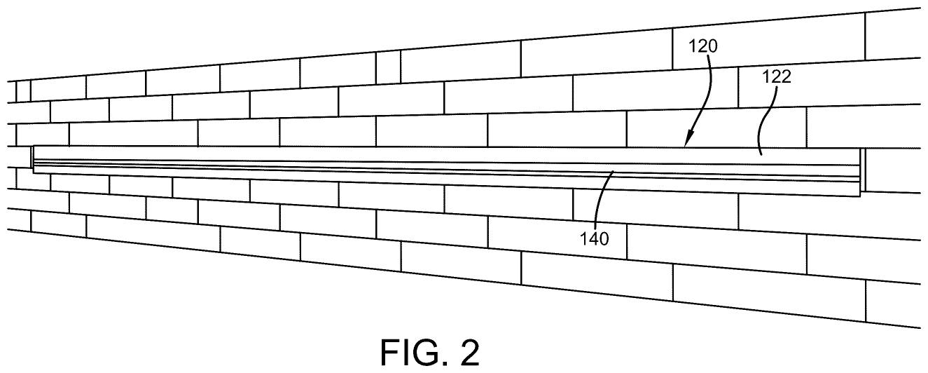

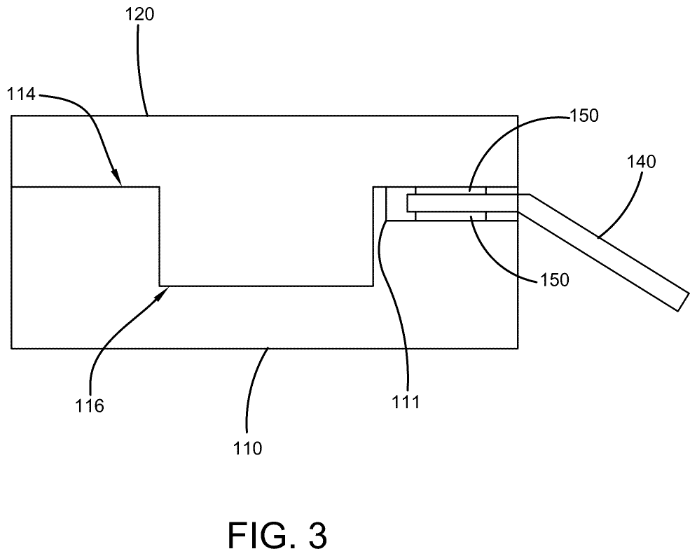

The top surface 122 of the steel member 120 may be comprised of at least one seal 140 in one embodiment, as seen in FIG. 2. The seal 140 is preferably comprised of a rubber material such as but not limited to an EPDM rubber, a silicone rubber, a thermoplastic elastomer, a neoprene, etc. that is resistant to shrinking, cracking, and warping while eliminating the ability for moisture, debris, and air to enter a garage through a perimeter opening of a garage door. The seal 140 is preferably positioned 45 degrees relative to a vertical axis (or in another embodiment, a horizontal axis) of the steel member 120 (i.e., such that the seal 140 points towards a perimeter of a garage door 10 while extending away from the top surface 122 and/or member 120 and plate 110). As a result, the seal 140 adequately seals the perimeter of the garage door 10. In a different embodiment, the seal 140 is positioned between and extends outward from (at the same 45-degree angle) the plate 110 and steel member 120. In this embodiment, a portion of the seal 140 may be flat (i.e., the portion between the retainer plate 110 and steel member 120), as seen in FIG. 3, and secured via a fastener 150 such as but not limited to double sided tape. The retainer plate 110 further holds the seal 140 level against a garage door. In one embodiment, the plate 110 may have a receiving area 111 such as a channel, a groove, etc. that receives a portion of the seal 140.

The retainer plate 110, steel member 120, and seal 140 may be any shape, size, and dimension in different embodiments.

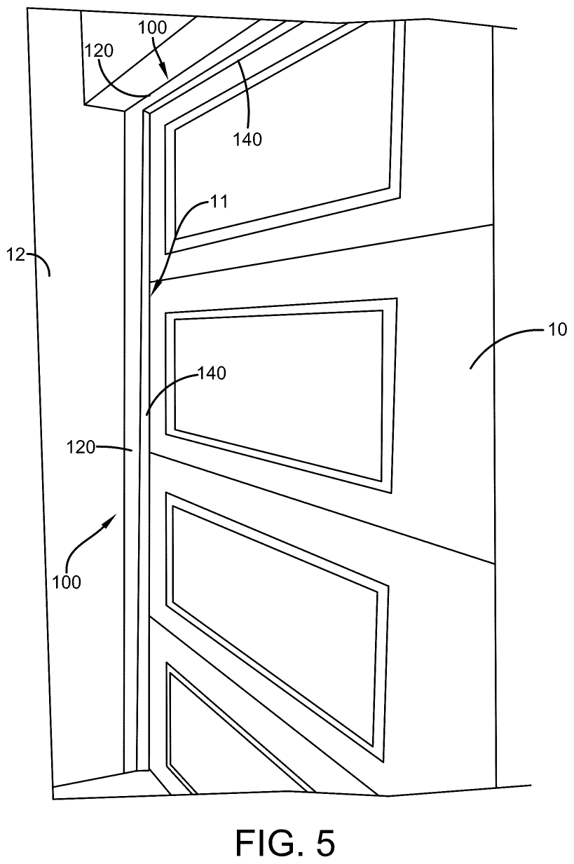

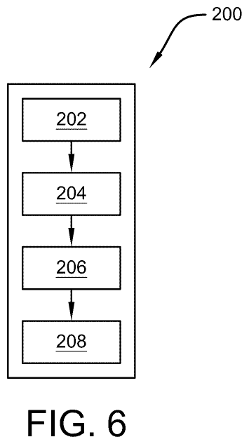

The present invention is also comprised of a method of using 200 the device 100, as seen in FIG. 6. First, a device 100 is provided comprised of a retainer plate 110 comprised of a first opening 112, a steel member comprised of a second opening 124, at least one fastener 130, and at least one seal 140 [Step 204]. Then, a portion of the seal 140 can be placed between the retainer plate 110 and steel member 120 [Step 206]. Finally, the retainer plate 110, seal 140, and steel member 120 can be placed in front of a garage door 10 (to the left, right, or top of the door 10) and secured into a garage door jamb 12 via driving the fastener 130 through the first opening 112 and second opening 124 and into the jamb 12 such that the seal 140 covers/seals a perimeter edge 11 of the garage door 10, as seen in FIG. 4 and FIG. 5 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “garage door perimeter sealing device” and “device” are interchangeable and refer to the garage door perimeter sealing device 100 of the present invention.

Notwithstanding the forgoing, the garage door perimeter sealing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the garage door perimeter sealing device 100 as shown in the FIGS. are for illustrative purposes only, and that many other sizes and shapes of the garage door perimeter sealing device 100 are well within the scope of the present disclosure. Although the dimensions of the garage door perimeter sealing device 100 are important design parameters for user convenience, the garage door perimeter sealing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A garage door perimeter sealing device comprising:
a retainer plate comprised of a first opening;
a steel member comprised of a second opening; and
a seal.

2. The garage door perimeter sealing device of claim 1, wherein the seal is comprised of a rubber material.

3. The garage door perimeter sealing device of claim 2, wherein the rubber material is comprised of an EPDM rubber, a silicone rubber, a thermoplastic elastomer, or a neoprene.

4. The garage door perimeter sealing device of claim 1, wherein the retainer plate is comprised of an aluminum.

5. The garage door perimeter sealing device of claim 1, wherein the steel member is comprised of a steel.

6. The garage door perimeter sealing device of claim 1, wherein the seal is positioned between the retainer plate and the steel member.

7. The garage door perimeter sealing device of claim 6, wherein the seal extends away from the steel member at a 45-degree angle relative to a horizontal axis of the steel member.

8. The garage door perimeter sealing device of claim 1, wherein the steel member is comprised of a simulative finish.

9. A garage door perimeter sealing device comprising:
a retainer plate comprised of a first opening;
a steel member comprised of a second opening;
a fastener; and
a rubber seal.

10. The garage door perimeter sealing device of claim 9, wherein the rubber seal is comprised of an EPDM rubber, a silicone rubber, a thermoplastic elastomer, a neoprene.

11. The garage door perimeter sealing device of claim 9, wherein the retainer plate is comprised of an aluminum.

12. The garage door perimeter sealing device of claim 9, wherein the steel member is comprised of a steel.

13. The garage door perimeter sealing device of claim 9, wherein the seal is positioned between the retainer plate and the steel member.

14. The garage door perimeter sealing device of claim 13, wherein the seal extends away from the steel member at a 45-degree angle relative to a horizontal axis of the steel member.

15. The garage door perimeter sealing device of claim 9, wherein the retainer plate is comprised of a receiving area that receives the steel member.

16. The garage door perimeter sealing device of claim 9, wherein the steel member is comprised of a simulative finish.

17. A method of using a garage door perimeter sealing device, the method comprising:
providing a garage door perimeter sealing device comprised of a retainer plate comprised of a first opening, a steel member comprised of a second opening, a fastener, and a seal;
placing a portion of the seal between the retainer plate and the steel member;
placing the retainer plate, the steel member, and the seal in front of a garage door and securing the retainer plate and the steel member into a garage door jamb, via driving a fastener through the first opening and the second opening and into the door jamb, such that the seal covers a perimeter edge of the garage door.

18. The method of using a garage door perimeter sealing device of claim 17, wherein the seal is comprised of a rubber seal.

19. The method of using a garage door perimeter sealing device of claim 17, wherein the retainer plate is comprised of an aluminum.

20. The method of using a garage door perimeter sealing device of claim 17, wherein the steel member is comprised of a steel.
